(19) United States
(12) Patent Application Publication
(10) Pub. No.: US 2013/0078515 A1
(43) Pub. Date: Mar. 28, 2013

(54) ELECTRONIC BATTERY WITH NANO-COMPOSITE

(71) Applicants: Glyn Jeremy Reynolds, Largo, FL (US); Rosalinda Martienssen, Dreieich (DE)

(72) Inventors: Glyn Jeremy Reynolds, Largo, FL (US); Werner Oskar Martienssen, Dreieich (DE)

(21) Appl. No.: 13/510,532

(22) PCT Filed: Nov. 22, 2010
(86) PCT No.: PCT/CH10/00296

§ 371 Date: Dec. 5, 2012

Related U.S. Application Data
(60) Provisional application No. 61/264,985, filed on Nov. 30, 2009.

(51) Int. Cl. H01M 4/583; H01M 4/04; H01M 4/62

(52) U.S. Cl. CPC H01M 4/583; H01M 4/62; H01M 4/0404
USPC 429/212; 429/207; 429/231.8; 29/623.1; 29/623.5

(57) ABSTRACT

A supercapacitor-like electronic battery exhibits a conventional electrochemical capacitor structure with a first nanocomposite electrode positioned within said conventional electrochemical capacitor structure. Said nanocomposite electrode shows nano-scale conductive particles dispersed in a electrolyte matrix, said nano-scale conductive particles being coated with a designed and functionalized organic or organometallic compound. A second nanocomposite electrode is positioned within said conventional electrochemical capacitor structure with similar properties. An electrolyte within said conventional electrochemical capacitor structure separates said first from said second nanocomposite electrode. Two current collectors in communication with said first and second nanocomposite electrode complete the electric scheme. A method for fabricating a capacitor includes forming conductive or semiconducting nanoparticles and reacting said nanoparticles with a first designed and functionalized organic or organometallic compound, said reaction forming an organic or organometallic shell surrounding each of said nanoparticles. Said treated nanoparticles are being dispersed into an electrolyte matrix to form a nanocomposite electrode.

### BACKGROUND

The world's known oil reserves are dwindling at an ever increasing rate as developing nations industrialize and demand increases. The price of oil exceeded $100 per barrel in 2008 and is very likely to become even more expensive in the future. For electricity generation, there are many alternatives to oil-fired power stations: natural gas, coal, nuclear and hydro-electric power stations are already widely deployed throughout the United States and other industrialized nations. However, burning both natural gas and coal leads to an increase of carbon dioxide levels in our atmosphere and as global warming accelerates and governments seek to address this growing concern, there has been much recent interest in renewable energy sources such as solar, wind and tides. It should be mentioned that although the percentage of our electricity generated by nuclear energy might increase in the future, this is no panacea. The public remember incidents at Chernobyl and Three Mile Island, and there are serious concerns about the radioactive waste that will remain hazardous for hundreds if not thousands of years. Furthermore, the use of nuclear energy for peaceful purposes nevertheless boosts the supply of fissionable fuel and increases the likelihood of nuclear proliferation with all its concomitant problems.

A multi-pronged problem such as this requires a strategy that incorporates several solutions. The aforementioned increase in the adoption of renewable sources of energy is a good start, but the world must also learn to reduce its energy consumption per capita and use its energy sources more effectively. One critical component needed to achieve these goals is efficient energy storage. Here again there will be many solutions: pumping water uphill, storing compressed gas in underground caverns, converting excess electrical energy to fuels such as hydrogen, flywheels, batteries and capacitors, just to name a few. Each solution has its preferred applications and currently, batteries and capacitors are the preferred methods of storing electrical energy in small and medium-sized portable electrical appliances. However, there is growing interest in the use of larger batteries and capacitors for vehicular propulsion and load leveling or power conditioning applications. Batteries and capacitors have also been proposed for storing energy from wind and photovoltaic generators to provide power at times when it is calm or dark, respectively.

As with most industrial operations, it requires energy to manufacture batteries and capacitors. Moreover, these devices do not, per se, create energy but they can result in more efficient use of energy. Therefore, it is important to consider the net energy balance of a particular battery or capacitor in a given application. If the energy storage device ends up saving more energy over its lifetime than was used in its fabrication, it results in valuable energy savings and likely reduction in overall CO₂ emissions. If, however, the reverse is true, the impression that the technology in question is a “green” energy-conserving technology is illusory. Rechargeable battery manufacturing is a relatively energy intensive operation: high energy density lithium-ion batteries in particular require high purity materials, some of which must be prepared at high temperatures. Many early lithium-ion batteries had limited cycle lives of just a few hundred cycles and their net energy balance in many typical portable electronic applications was negative. They did provide better performance for a given size and weight and therefore reduced the overall size and weight of the device—before the severity of global warming and diminishing energy reserves was fully appreciated, this was the primary consideration. For vehicular propulsion and power station applications, it is critical that the net energy balance of the batteries is positive and that their lifetimes are sufficient to justify their use. By their very nature, the electrodes in electrochemical batteries undergo chemical changes during charging and discharging. These can be in the form of phase changes, structural changes and/or volume changes, all of which can severely degrade the integrity of the electrodes over time and reduce the capacity of the battery. Indeed, the charging and discharging processes in the latest generation lithium-ion batteries must be carefully controlled—overcharging or over-discharging can limit the performance and cause premature failure of the battery.

In contrast, capacitors store their energy as electrical charge on the electrodes. No chemical changes are involved and most capacitors have cycle lives of a million cycles or more, to 100% depth-of-discharge. Capacitors can also be charged and discharged orders of magnitude faster than electrochemical batteries making them particularly attractive for capturing rapidly released energy such as in falling elevator and automobile regenerative braking applications. Traditional electrostatic and electrolytic capacitors are used widely in electrical circuit applications but can store only relatively small amounts of energy per unit weight or volume. The emergence of electrochemical double layer (EDL) capacitors has now provided a viable alternative to traditional electrochemical batteries where power density and cycle life are more important than energy density. In fact, the latest generation EDL Supercapacitors have specific energies of ˜25 Wh/kg, approximately the same as lead-acid electrochemical cells.

### PRIOR ART

It has long been appreciated that very large capacitances exist at the interface between an electrolyte and an irreversible electrode. See R. Kotz and M. Carlen, “Principles and Applications of Electrochemical Capacitors,” Electrochimica Acta 45,2483-2498 (2000). This phenomenon is exploited in today's commercially available electrochemical double layer (EDL) supercapacitors (sometimes referred to as “ultracapacitors”). See “Basic Research Needs for Electrical Energy Storage”, Report of the Basic Energy Science Workshop in Electrical Energy Storage. U.S. Department of Energy, April 2007.” The accepted mechanism for this dates back to 1853, when von Helmholtz discovered the electrochemical double layer. See H. von Helmholtz, Ann. Phys. (Leipzig) 89 (1853) 211. If two electrodes are immersed in an electrolyte, a single layer of negative ions from the electrolyte will form in close proximity to the positive electrode and a second layer of electrolyte with a preponderance of positive ions will form proximate the aforementioned negative ions, forming the so-called “Helmholtz double layer.” A similar process occurs at the opposite negative electrode, though in this case the positive ions form the layer closest to the electrode—this is shown schematically in FIG. 1.

Because this double layer forms only at the interface between electrode and electrolyte, it is necessary to create a structure that maximizes this interfacial region. Traditionally, EDL supercapacitors have been made with high surface area carbon powders and aqueous electrolytes. See B. E. Conway, Electrochemical Supercapacitors—Scientific Fundamentals and Technological Applications, Kluwer, New York, 1999. However, the capacitance of an EDL supercapacitor does not always scale with surface area. The most porous carbon powders with the highest surface areas as measured by BET methods sometimes have lower capacitances than other, lower surface area materials. This is usually explained as due to the fact that some pores are the wrong size to form double layer structures.

Some authors have investigated capacitors that use pseudocapacitance to boost the effective capacitance of an electrode material. In addition to the energy stored by charge separation in the Helmholtz double layer, pseudocapacitors stabilize stored charge in the electrode material by changing the oxidation state of one of the constituents, usually a transition metal that exhibits multiple oxidation states. In this respect, pseudocapacitors are similar to electrochemical batteries but with a very important difference: in many electrochemical batteries, for example, lithium-ion cells, the change in oxidation state of the variable oxidation state metal is accompanied by solid state diffusion of the mobile ion from the electrolyte into the bulk of the active electrode material (in lithium-ion cells, lithium ions diffuse into the bulk of the active electrode material). This process leads to structural changes in the active electrode material and is believed to be a major factor that contributes to the limited cycle lives of rechargeable electrochemical batteries. In contrast, true pseudocapacitance occurs only at the surface—mobile ions from the electrolyte do not diffuse into the bulk of the active electrode material. Ruthenium dioxide (RuO₂) and manganese dioxide (MnO₂) have been proposed as active materials for pseudocapacitors. In several US patents issued to date. Lee et al. described pseudocapacitors containing carbon/amorphous manganese dioxide electrodes that exhibited high specific capacitances in excess of 600 F/g.

Capacitors and pseudocapacitors based on aqueous electrolytes are usually limited to maximum operating cell voltages of slightly over IV—higher voltages lead to unwanted electrolysis of the electrolyte. More recent EDL supercapacitors have used organic solvent-based electrolytes. See K. Yuyama, G. Masuda, H. Yoshida, and T. Sato, “Ionic liquids containing the tetrafluoroborate anion have the best performance and stability for electric double layer capacitor applications,” Journal of Power Sources 162, 1401 (2006); polymeric electrolytes (Polymer Capacitor Catching Up with Li-ion Battery in Energy Density, http://techon.nikkeibp.co.jp/english/NEWS_EN/20090615/171726) to boost the maximum voltage between electrodes without initiating electrolysis of the electrolyte. This in turn boosts the maximum energy than can be stored in these capacitors. Recently, Eamex Corporation has claimed an energy density of 600 Wh/liter for a hybrid-EDL supercapacitor that contains a negative electrode that can reversibly incorporate mobile lithium ions from the polymeric electrolyte. Id.

### Disadvantages of the Prior Art

Compared to electrochemical batteries, existing EDL supercapacitors store relatively small amounts of electrical energy per unit mass or volume and they are electrically leaky, meaning that they cannot store their charge over extended periods of time. They have a lower cycle life and peak power output than electrostatic capacitors, though here they are vastly superior to electrochemical batteries.

The aforementioned hybrid-EDL supercapacitor that uses one electrode that can reversibly incorporate mobile lithium ions from the polymeric electrolyte has one of the drawbacks associated with electrochemical batteries, namely that chemical changes take place during charge/discharge cycles (see id.), lithium ions undergo a redox reaction at the negative electrode, forming a lithium alloy when the device is charged). Such chemical reactions may compromise the overall cycle life of these hybrid capacitors.

Lee et al. (H-Y. Lee, H-S. Kim, W-K. Seong and S-W. Kim, “Metal oxide electrode for supercapacitor and manufacturing method thereof”, U.S. Pat. No. 6,339,528; “Metal oxide electrochemical psedocapacitor employing organic electrolyte”, U.S. Pat. No. 6,496,357; “Metal oxide electrochemical pseudocapacitor having conducting polymer coated electrodes”, U.S. Pat. No. 6,510,042; and “Manufacturing method for a metal oxide electrode for supercapacitor”, U.S. Pat. No. 6,616,875) described a method for fabricating an electrode comprising carbon, amorphous manganese dioxide and conductive polymer but their device is not optimized for several reasons:

1) Their method for combining carbon and manganese oxide does not control the amount and thickness of amorphous manganese dioxide incorporated into their electrode structure. This is important because manganese dioxide is widely used as an active cathode material in Leclanché, alkaline manganese and primary lithium batteries: in these devices, hydrogen and lithium ions are known to intercalate into the manganese dioxide and lead to structural changes—it is worth noting that none of these batteries are considered rechargeable. If the electrodes in the capacitors described by Lee et al. [7-10] are kept charged for any length of time, there is the possibility that solid state diffusion of hydrogen or lithium ions can occur into regions of manganese dioxide that are not in intimate contact with the electrolyte, i.e., not at the surface. Repeated cycling could lead to structural changes in the bulk of the manganese dioxide and compromise the cycle life of the capacitor.

2) The use of an electrically conducting polymer as a “binder” to ensure good electrical contact between the active material (manganese dioxide) and the carbon particles that impart electrical conductivity to the electrode will act to prevent intimate contact between the electrolyte and the active material, reducing the effective surface area. This effect will also serve to exacerbate the problem described in 1) above.

3) The inventors do not provide means to control the sizes and distribution of the pores in their composite electrodes. Thus, some of the pores will be too small for the electrolyte to penetrate and the active material in these pores will not contribute to the overall cell capacitance, while other pores will be larger than optimum and will therefore lower the overall average capacitance density.

### SUMMARY

The following simplified summary is provided in order to provide a basic understanding of some aspects of the claimed subject matter. This summary is not an extensive overview, and is not intended to identify key/critical elements or to delineate the scope of It is the purpose of this invention to describe a means to fabricate a capacitor with a very high specific energy compared to existing electrochemical supercapacitors and ultracapacitors while still retaining the high cycle life and power densities exhibited by true capacitors. The novel device contains one or more electrodes whose structure is comprised of an electrolyte into which is dispersed conductive nanoparticles. The size and size distribution of these nanoparticles can be controlled very precisely. Prior to dispersion in the electrolyte matrix, the nanoparticles are coated with an organometallic compound that contains a metal atom (or atoms) that can exhibit multiple oxidation states. This organometallic compound is engineered to prevent agglomeration of the conductive nanoparticles while serving to facilitate transfer of electronic charge between said conductive nanoparticles and the metal atom (or atoms) capable of exhibiting multiple oxidation states. In addition, said organometallic compound should be functionalized to wet the surrounding electrolyte matrix and ensure the reversible approach of mobile ions as the state of charge of the capacitor changes.

Because this pseudocapacitor exhibits many of the characteristics of an electrochemical battery while storing most of its energy by charge separation, we have coined the term “electronic battery” to describe such a device.

### BRIEF DESCRIPTION OF THE DRAWINGS

FIG. 1 is a schematic representation of an electrochemical double layer.

FIG. 2 is a schematic representation of a cross-section of a single cell of an electronic battery.

FIG. 3a is a schematic representation of a hypothetical aliphatic organometallic compound for use in a pseudocapacitor of the currently disclosed embodiments.

FIG. 3b is a schematic representation of a hypothetical aromatic organometallic compound for use in a pseudocapacitor of the currently disclosed embodiments.

FIG. 4 is a diagram of a pentafluoro-aryl group.

FIG. 5 is a diagram of a chitin molecule.

FIG. 6 is a schematic representation of conductive nanoparticles with organometallic

FIG. 7 is a schematic representation of a cross-section of a multi-layer electronic battery (bipolar configuration).

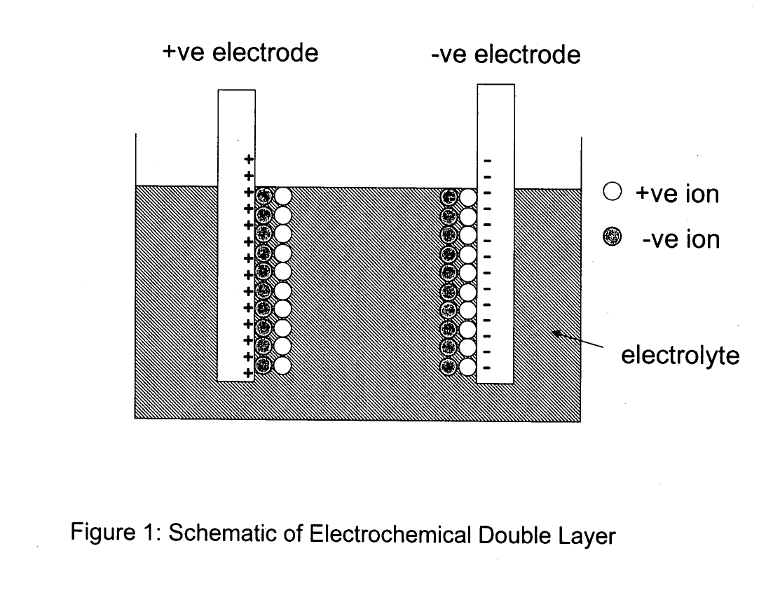

### DETAILED DESCRIPTION

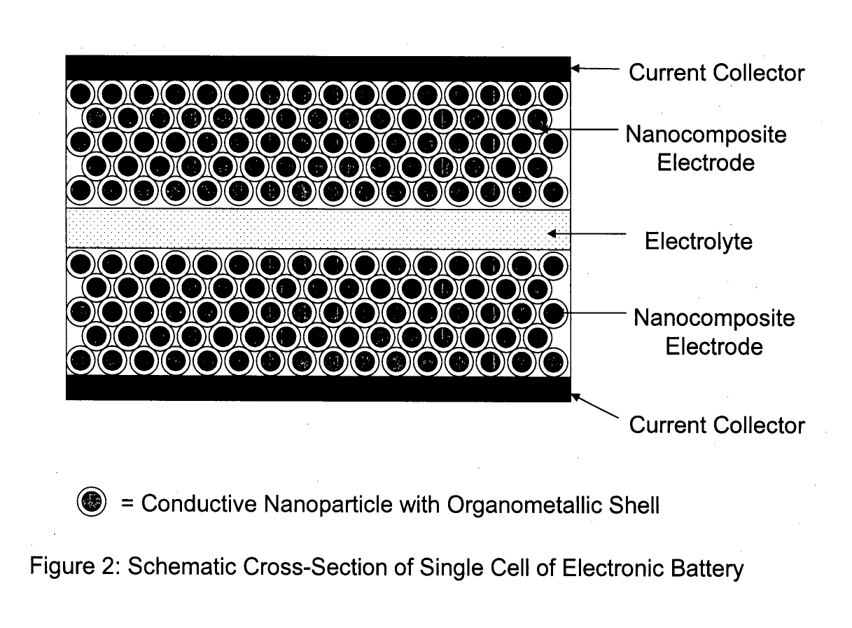

A schematic of the cell structure of an electronic battery according to the current invention is shown in FIG. 2. The cell comprises the conventional electrochemical capacitor structure: two electrodes are separated by a region that contains only electrolyte and are provided with current collectors on their opposing faces. The electrolyte can take the form of an aqueous solution of a dissolved ionic chemical compound (or compounds), a non-aqueous solution of a dissolved chemical compound (or compounds), a polymer electrolyte, a gel electrolyte, a solid electrolyte or a molten salt electrolyte. In cases where the electrolyte is a liquid or a gel, it should contain a porous non-conductive solid to prevent the two conductive electrodes from shorting together, since it is advantageous that the gap between the two electrodes is kept very small to minimize equivalent series resistance (ESR) and maximize energy density of the capacitor. In the case where the electrolyte is a molten salt, it may be particularly advantageous to incorporate the structure described in S. V. Pan'kova, V. V. Poborchii and V. G. Solov'ev, “The giant dielectric constant of opal containing sodium nitrate nanoparticles”, J. Phys.; Condensed Matter 8, L203-L206 (1996) where a molten salt electrolyte is chemically infiltrated into a synthetic opal framework. It should be recognized that the porous matrix need not be limited to synthetic opal (SiO₂) structures but that insulating matrices of alumina, alumino-silicates, etc. that are known to those skilled in the art could also be infiltrated with molten salt electrolytes, for example, those based on the low melting temperature nitrates of lithium and potassium, and on AlCl₃ with suitable additives (e.g., NaAlCl₄) that are known to lower its melting point and increase its ionic conductivity.

The electrodes themselves are each nanocomposites: they are comprised of nano-scale conductive particles, in a preferred embodiment <100 nm in diameter, dispersed in an electrolyte matrix. The electrolyte matrix can take the form of an aqueous solution of a dissolved ionic chemical compound (or compounds), a non-aqueous solution of a dissolved chemical compound (or compounds), a polymer electrolyte, a gel electrolyte, a solid electrolyte or a molten salt electrolyte. The concentration of the conductive nanoparticles should exceed the percolation threshold of the material, thereby ensuring that the electrodes are electrically conducting, up to a maximum of ˜74% volume fraction, the maximum that can be achieved by close packing spheres.

In order to prevent the conductive nanoparticles from agglomerating, they are coated with an organic or organometallic compound. This compound is designed and functionalized to serve as many as five complementary purposes.

1) It should prevent agglomeration of the conductive nanoparticles.

2) It should contain a functional group that causes it to attach firmly to the conductive nanoparticles.

3) It should contain a functional group that causes it to be wetted by the electrolyte matrix.

4) It should contain one or more atoms of an element that exhibits variable oxidation states.

5) It should contain a carbon skeleton that is partially unsaturated so as to form conjugated double bonds that facilitate the transfer of charge from the conductive nanoparticles to the variable oxidation state atom (or atoms) in the said organometallic compound.

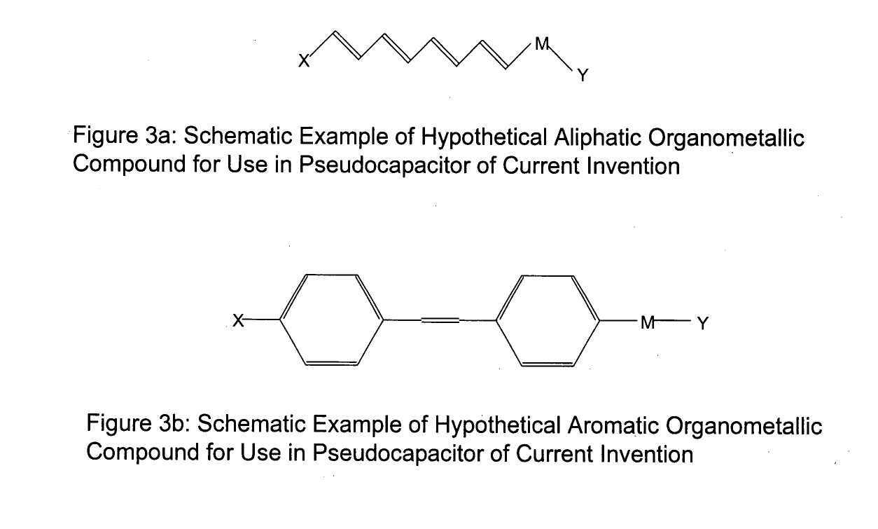

In practice, it is not necessary that the organic or organometallic compound performs all five of the functions listed above, for example, if it is desired to fabricate a true EDL supercapacitor rather than a pseudocapacitor, there is no need that the said organic or organometallic compound contain atoms of variable oxidation state. Similarly, for nanocomposites that are sufficiently conductive and where charge can readily transfer between the conductive nanoparticles and the atom (or atoms) of variable oxidation state without the assistance provided by a series of conjugated carbon-carbon double bonds, then clearly this latter functionality can be omitted in the said organic or organometallic compound. A schematic representation of a candidate organometallic compound that exhibits all of the functions listed above is shown in FIG. 3a.

The principle of surrounding nanoparticles with materials containing long carbon chains is well-established. The molecules surround the individual nanoparticles completely and keep them sufficiently far apart to prevent grain growth and/or agglomeration. However, many long chain aliphatic carbon compounds are good insulators and are not well suited to incorporation into the electrode of a supercapacitor or pseudocapacitor. Thus, aromatic or chains containing unsaturated carbon-carbon bonds are preferred for the application described here. A schematic representation of a candidate aromatic organometallic compound that exhibits all of the functions listed above is shown in FIG. 3b.

The conductive nanoparticles can be selected from a variety of conductive materials including all metals and semiconductors. In a preferred embodiment, light, highly conductive materials are preferred: lighter particles lead to higher specific energies while higher electrical conductivities reduce the Equivalent Series Resistance (ESR), increasing the specific power of the device. In applications where energy per unit volume (energy density) is more important than energy per unit weight (specific energy), heavier conductive nanoparticle materials can be considered where they are more cost effective. Similarly, since the power density of a capacitor is typically orders of magnitude larger than that of a comparable electrochemical battery, it may be acceptable to substitute less conductive nanoparticle materials if they are less expensive or offer other advantages.

Because it is light, relatively conductive and inexpensive, high surface area carbon powder is the preferred conductor in most of the supercapacitors available on the market today. Graphene, in the form of sheets, buckyballs or nanotubes, is even more conductive though much more expensive. Though nanoparticles of carbon in its many conductive forms could be considered as a conductive additive for the electrodes of this invention, it cannot be used as typically described in the prior art. Care should be taken to prepare the nanoparticles of carbon with the requisite size and size distribution: in a preferred embodiment, the particle sizes should be ≦100 nm and optimally, the sizes of the nanoparticles should vary from their mean value by less than about ±10%. Typically, a carbon surface is quite inert: in order to surround the carbon nanoparticles with the organometallic compounds described in this invention, it is desirable to treat the carbon nanoparticles so that their surfaces will bond to other materials. This process of activating carbon surfaces is well-established and can be accomplished by treatment with oxygen, chlorine, etc. Once activated, the carbon surface will readily adsorb, or in some cases, chemisorb non-polar molecules. Thus, when carbon is used for the conductive nanoparticles in the current invention, in one preferred embodiment, it is desirable that the functional group represented schematically by letter X in FIGS. 3a and 3b present a non-polar point of attachment to the activated carbon surface: this can be achieved in cases where X is an —H, —OH, halogen or pseudohalogen atom or group. Alternatively, the carbon surface can itself be functionalized with hydrogen, hydroxyl, oxygen, halogen or pseudohalogen atoms or groups and an organic chemical reaction can be instigated to chemically attach another material to the carbon surface. There are many possible organic reactions that can be used to perform this attachment and it is beyond the scope of this invention to provide an exhaustive list of the many ways that this can be achieved, which are known to those skilled in the art. One effective means for forming carbon-carbon bonds is by use of a Grignard reagent (see V. Grignard, “Sur quelques nouvelles combinaisons organométaliques du magnésium et leur application à des synthèses d'alcools et d'hydrocabures”, Compt. Rend. 130, 1322-1325 (1900)); another is the Wittig reaction (see G. Wittig and U. Schöllkopf, “Über Triphenyl-phosphin-methylene als olefinbildende Reagenzien I”, Chemische Berichte 87, 1318 (1954))—both are well known to those skilled in the art. Once the surface of the carbon nanoparticles have reacted so that they are surrounded by carbon chains of the requisite lengths, these chains can be further functionalized to add variable oxidation state atoms and/or other functional groups to ensure good wetting of the carbon nanoparticle surrounded by its organometallic shell to the electrolyte matrix.

In cases where materials other than carbon are used as the conductive nanoparticles, similar principles are used to attach the organometallic shells as in the alternative method described for carbon, namely, a chemical reaction between the desired organometallic compound and the conductive nanoparticle is instigated. The metals of Group 11 (or Group 1B) of the periodic table, Cu, Ag and Au, are particularly conductive and nanoparticles of these materials can be made routinely by those skilled in the art. The principle of forming nanoparticles of these materials that are surrounded by organic compounds to prevent agglomeration is well-established. See Y-I. Lee, J-R. Choi, K-J. Lee, N. E. Stott and D-H. Kim, “Large-scale synthesis of copper nanoparticles by chemically controlled reduction for applications of inkjet-printed electronics”. Nanotechnology 19, 415604 (2008); J-S.Kim, J-H. Moon, S-H. Jeong, D-J. Kim and B-Y. Park, “Copper nanoparticles, method of preparing the same and method of forming copper coating film using the same”, US Patent Application 2007/0180954; and Y. Shen, Y. Lin, M. Li and C-W. Nan, “High dielectric Performance of Polymer Composite Films Induced by a Percolating Interparticle Barrier Layer”, Adv. Mater. 19, 1418-1422 (2007). After forming the protective organic shell around the conductive nanoparticles, the resultant species are subjected to further chemical reactions to form the desired functionality.

In cases where the conductive nanoparticles are prone to forming passivating oxides on their surfaces, e.g., Al, Ti or Zr particles, it can be advantageous to functionalize the organometallic compound with a phosphonic acid group {X=—PO(OH)₂}, a sulphonic acid group {X=—SO₂OA, where A=H or alkali metal}, a trialkoxysilane group X=—Si(OR)₃, where R=alkyl group) or a carboxyllic acid group {X=—CO₂H}. Phosphonic acid groups in particular have been found to be effective in preventing nanoparticles of ternary and quaternary titanates from agglomerating in polymeric matrices. See P. Kim, S. C. Jones, P. J. Hotchkiss, J. N. Haddock, B. Kippelen, S. R. Marder and J. W. Perry, “Phosphonic Acid-Modified Barium Titanate Polymer Nanocomposites with High Permittivity and Dielectric Strength”, Adv. Mater. 19, 1001-1005 (2007).

The one or more atoms that exhibit variable oxidation states should consist of a transition metal, a lanthanide or a so-called B metal or semi-metal (the latter drawn from groups 13-15 (former groups III-VB) of the periodic table). It is beyond the scope of this invention to describe the many ways in which organometallic compounds that incorporate such elements can be fabricated but these are well known to those skilled-in-the-art and many such compounds and their preparations are documented in Gmelin (see Gmelin Handbook of Inorganic and Organometallic Chemistry, Springer-Verlag) and other scholarly texts. When used in the positive electrode of a pseudocapacitor where anions will form the first layer adjacent to the conductive elements of the electrode, it is advantageous to design the organometallic compound such that the element with the variable oxidation state contained therein is in a low oxidation state, e.g., V²⁺, Mn²⁺, Fe²⁺, etc., that can be readily oxidized to a higher oxidation state, e.g., V²⁺→N³⁺, Mn²⁺→Mn⁴⁺, Fe²⁺→Fe³⁺, etc. At the negative electrode where cations will form the first layer adjacent to the conductive elements of the electrode, the principle is reversed and the organometallic compound should preferably contain an element with a variable oxidation state in an oxidation state that can be readily reduced, e.g., V⁵⁺→V⁴⁺, Mn⁴⁺→Mn²⁺, Fe³⁺→Fe²⁺, etc.

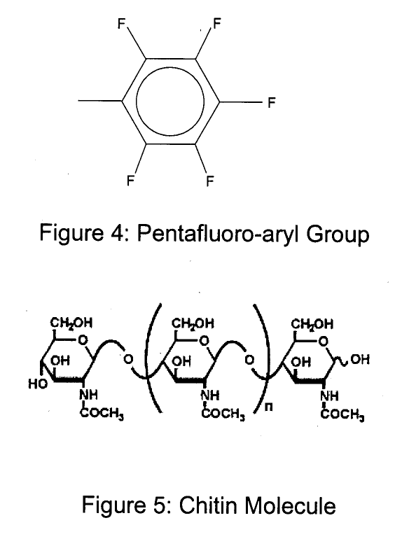

The choice of the functional group, Y, that ensures the conductive nanoparticles and their organometallic shells are wetted by the electrolyte matrix depends on the electrolyte. If the electrolyte is a highly polar aqueous solution, resin, solvent or ionic molten salt, Y should be a highly polar functional group such as an organic alcohol group (—OH) or a polyglycol group. In cases where the electrolyte contains a fluoropolymer or a non-aqueous solvent, Y can be, for example, a fluorinated aryl group (see FIG. 4).

Although it does not contain conjugated double bonds, the polysaccharide chitin (FIG. 5) has been used to prevent the agglomeration of nanoparticles in a matrix. It can also be readily modified to incorporate transition metal atoms such as iron and can be used to perform several of the functions required of the organic shell for the electronic batteries described in this invention.

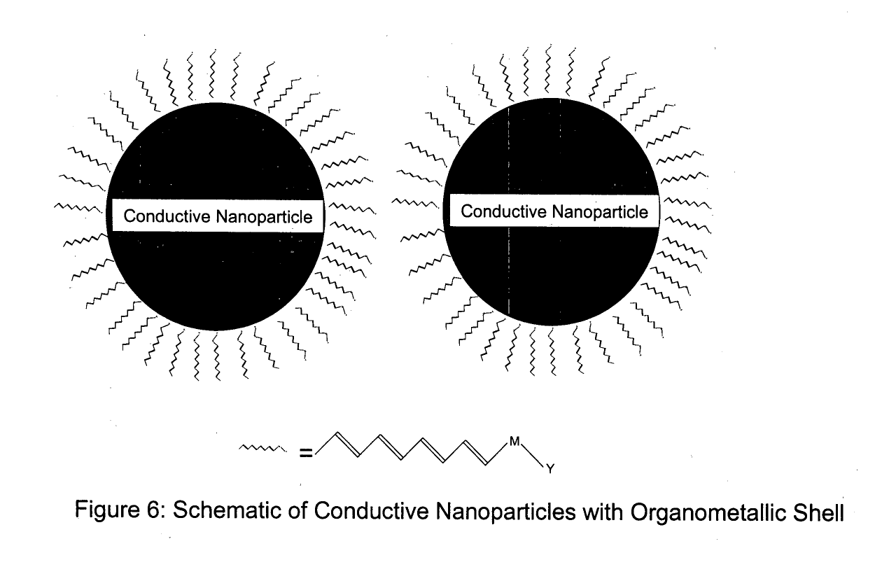

A schematic of conductive nanoparticles surrounded by an organometallic compound according to the teachings of this invention is shown in FIG. 6.

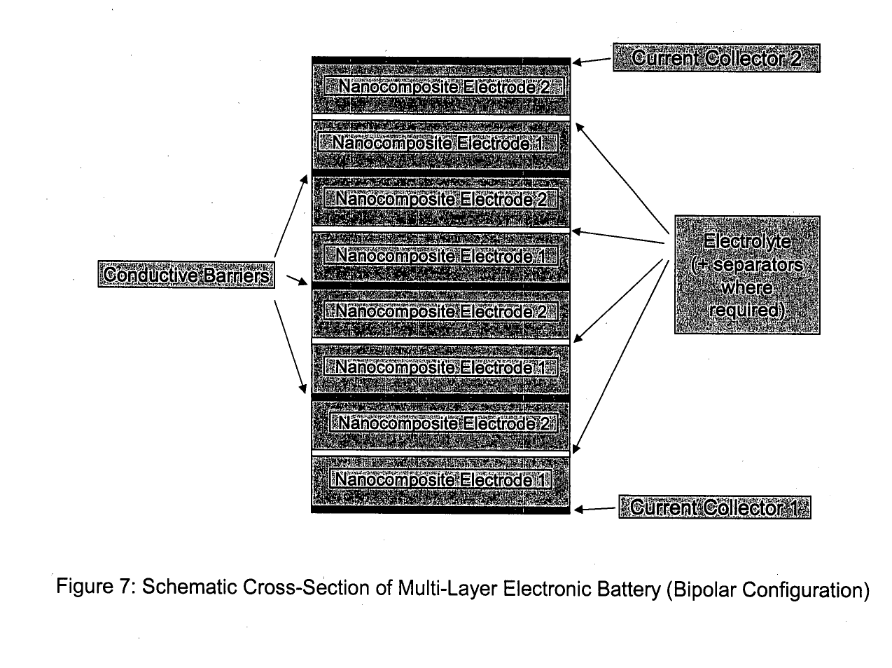

For a single cell of the invention described herein, the maximum voltage across the electrodes is limited by the electrochemical stability range of the electrolyte. For thermodynamic stability, this is limited to ˜7V, though some solid electrolytes have kinetic stability limits that are significantly higher. By stacking individual cells together in a bipolar configuration as shown in FIG. 7, it is possible to fabricate electronic batteries with much higher operating voltage ranges (hundreds of volts, kV or even MV), limited only by practical considerations. Such stacks would require control circuitry to account for differences in impedance between the various cells during charging and discharging, but this technology has already been developed for lithium-ion batteries (see R. S. Tichy and M. Borne, “Building Battery Arrays with Lithium-Ion Cells”, Micro Power Webinar, March 2009) and could easily be modified to function with high voltage serially connected electronic battery stacks. Note that the composition of the positive and negative electrodes of the electronic battery structure described herein may be formulated differently and this distinction is emphasized in FIG. 7 by use of the terminology “Nanocomposite Electrode 1” and “Nanocomposite Electrode 2”.

We now describe a sequence for fabricating a single cell of an electronic battery according to the present invention. First, conductive or semiconducting nanoparticles are made according to prior art. In a preferred embodiment, these nanoparticles have diameters ≦100 nm, with a narrow size distribution, optimally within ±10% of their nominal size. In a second step, these nanoparticles are reacted with an organic compound that is functionalized to attach to the surface of the nanoparticles and prevent agglomeration. In a third and fourth step, an atom (or atoms) of variable oxidation state is incorporated into the organic shell surrounding the nanoparticles and the shell is modified so that it is wetted by the electrolyte medium of choice. Two or more of steps 2-4 can be combined into a single chemical reaction, depending on the functionality that is desired and the availability of suitable organometallic compounds.

In a fifth step, the conductive nanoparticles surrounded by their organometallic shells are dispersed in an electrolyte matrix above the percolation limit where the nanocomposite becomes electronically conductive. In a preferred embodiment, the amount of nanoparticles dispersed in the electrolyte matrix should exceed 50% by volume up to the limit of 74% by volume. The electrolyte matrix should be in a liquid state while the nanoparticles are dispersed therein. In cases where the electrolyte is a polymer electrolyte, the nanoparticles should be dispersed prior to final polymerization. In cases where the electrolyte is a molten salt, the nanoparticles should be added while it is in its molten state. This step should be performed in a container of appropriate size and shape to hold the nanocomposite electrode in place for subsequent fabrication steps. One surface of said container should be conductive to act as a current collector in the final assembly.

In a sixth step, the electrolyte (and if required, porous separator) should be applied to the nanocomposite electrode. The electrolyte can be in the form of an aqueous solution of a dissolved ionic chemical compound (or compounds), a non-aqueous solution of a dissolved chemical compound (or compounds), a polymer electrolyte, a gel electrolyte, a solid electrolyte or a molten salt electrolyte: there are a myriad of electrolyte materials used in batteries and electrochemical capacitors that are suitable for use in the device described here and that are well known to those skilled in the art.

In a seventh step, a second nanocomposite electrode prepared in a manner analogous to the method described in steps 1-5, is introduced onto the electrolyte on the side opposing the first nanocomposite electrode. A conductive surface is placed in contact with the second nanocomposite electrode (but electrically isolated from the first nanocomposite electrode) so as to act as a current collector and the device is sealed. Alternatively, both current collectors can be fabricated by using thin film or thick film coating methods to apply a conductive material to the sides/faces of the nanocomposite electrodes opposing the electrolyte/separator.

It is a simple exercise to build a multi-layer device of two or more cells according to the method described herein. It is also possible to amend the fabrication methods described herein to produce a spirally wound structure: such methods are practiced and well understood by those skilled in the art.

It should be recognized that there are many ways that the principles described herein can be implemented by those skilled in the art and the specific materials and methods mentioned should not be used to limit the scope of this invention.

What is claimed is:

1. A supercapacitor-like electronic battery comprising:
a conventional electrochemical capacitor structure;
a first nanocomposite electrode positioned within said conventional electrochemical capacitor structure, said first nanocomposite electrode having first nano-scale conductive particles dispersed in a first electrolyte matrix, said first nano-scale conductive particles being coated with a first designed and functionalized oranic or organometallic compound;
a second nanocomposite electrode positioned within said conventional electrochemical capacitor structure, said second nanocomposite electrode having second nano-scale conductive particles dispersed in a second electrolyte matrix, said second nano-scale conductive particles being coated with a second designed and functionalized organic or organometallic compound;
an electrolyte within said conventional electrochemical capacitor structure, said electrolyte separating said first nanocomposite electrode from said second nanocomposite electrode;
a first current collector in communication with said first nanocomposite electrode; and
a second current collector in communication with said second nanocomposite electrode.

2. The supercapacitor-like electronic battery according to claim 1, further comprising:
said first nano-scale conductive particles further comprising a first diameter of less than 100 nm; and
said second nano-scale conductive particles further comprising a second diameter of less than 100 nm.

3. The supercapacitor-like electronic battery according to claim 1, further comprising:
said first nano-scale conductive particles having a first concentration such that the percolation threshold of said first nano-scale conductive particles in said first nanocomposite electrode is exceeded; and
said second nano-scale conductive particles having a second concentration such that the percolation threshold of said second nano-scale conductive particles in said second nanocomposite electrode is exceeded.

4. The supercapacitor-like electronic battery according to claim 1, further comprising:
said first designed and functionalized organic or organometallic compound serving to prevent agglomeration of said first nano-scale conductive particles; and
said second designed and functionalized organic or organometallic compound serving to prevent agglomeration of said second nano-scale conductive particles.

5. The supercapacitor-like electronic battery according to claim 1, further comprising:
said first designed and functionalized organic or organometallic compound further comprising a first functional group; and
said second designed and functionalized organic or organometallic compound further comprising a second functional group.

6. The supercapacitor-like electronic battery according to claim 5, further comprising:
said first functional group being wetted by said first electrolyte matrix; and
said second functional group being wetted by said second electrolyte matrix.

7. The supercapacitor-like electronic battery according to claim 1, further comprising:
said first designed and functionalized organic or organometallic compound further comprising a third functional group; and
said second designed and functionalized organic or organometallic compound further comprising a fourth functional group.

8. The supercapacitor-like electronic battery according to claim 7, further comprising:
said third functional group facilitating the attachment of said designed and functionalized organic or organometallic compound to said first nano-scale conductive particles; and
said fourth functional group facilitating the attachment of said designed and functionalized organic or organometallic compound to said second nano-scale conductive particles.

9. The supercapacitor-like electronic battery according to claim 1, further comprising:
said first designed and functionalized organic or organometallic compound further comprising a first element exhibiting variable oxidation states; and
said second designed and functionalized organic or organometallic compound further comprising a second element exhibiting variable oxidation states.

10. The supercapacitor-like electronic battery according to claim 1, further comprising:
said first designed and functionalized organic or organometallic compound further comprising a first partially unsaturated carbon skeleton; and
said second designed and functionalized organic or organometallic compound further comprising a second partially unsaturated carbon skeleton.

11. The supercapacitor-like electronic battery according to claim 1, further comprising:
said first designed and functionalized organic or organometallic compound further comprising a first aliphatic organometallic compound; and
said second designed and functionalized organic or organometallic compound further comprising a second aliphatic organometallic compound.

12. The supercapacitor-like electronic battery according to claim 1, further comprising:
said first designed and functionalized organic or organometallic compound further comprising a first aromatic organometallic compound; and
said second designed and functionalized organic or organometallic compound further comprising a second aromatic organometallic compound.

13. The supercapacitor-like electronic battery according to claim 1, further comprising:
said first nano-scale conductive particles further comprising carbon powder; and
said second nano-scale conductive particles further comprising carbon powder.

14. A method for fabricating a capacitor comprising:
forming first conductive or semiconducting nanoparticles;
reacting said first conductive or semiconducting nanoparticles with a first designed and functionalized organic or organometallic compound, said reaction forming a first organic or organometallic shell surrounding each of said first conductive or semiconducting nanoparticles;
incorporating at least one first atom with a variable oxidation state into each of said first organic or organometallic shells surrounding said first conductive or semiconducting nanoparticles;
dispersing said first conductive or semiconducting nanoparticles surrounded by their said first organic or organometallic shells into a first electrolyte matrix to form a first nanocomposite electrode, said first nanocomposite electrode having a first surface and a second surface;
applying an electrolyte to the first surface of said first nanocomposite electrode;
forming second conductive or semiconducting nanoparticles;
reacting said second conductive or semiconducting nanoparticles with a second designed and functionalized organic or organometallic compound, said reaction forming a second organic or organometallic shell surrounding each of said second conductive or semiconducting nanoparticles;
incorporating at least one second atom with a variable oxidation state into each of said second organic or organometallic shells surrounding said second conductive or semiconducting nanoparticles;
dispersing said second conductive or semiconducting nanoparticles surrounded by their said second organic or organometallic shells into a second electrolyte matrix to form a second nanocomposite electrode, said second nanocomposite electrode having a third surface and a fourth surface;
applying said third surface of said second nanocomposite electrode to said applied electrolyte;
placing a first current collector in communication with said second surface of said first nanocomposite electrode; and
placing a second current collector in communication with said fourth surface of said second nanocomposite electrode.

15. The method according to claim 14, further comprising sealing said first nanocomposite electrode, said second nanocomposite electrode, said electrolyte, said first current collector and said second current collector.

16. The method according to claim 14, further comprising:
said first conductive or semiconducting particles further comprising a first diameter of less than 100 nm; and
said second conductive or semiconducting particles further comprising a second diameter of less than 100 nm.

17. The method according to claim 14, further comprising:
said first nano-scale conductive particles having a first concentration such that the percolation threshold of said first conductive or semiconducting particles in said first nanocomposite electrode is exceeded; and
said second conductive or semiconducting particles having a second concentration such that the percolation threshold of said second nano-scale conductive particles in said second nanocomposite electrode is exceeded.

18. The method according to claim 14, further comprising:
said first organic or organometallic shell serving to prevent agglomeration of said first conductive or semiconducting particles; and
said second organic or organometallic shell serving to prevent agglomeration of said second conductive or semiconducting particles.

19. The method according to claim 14, further comprising:
said first designed and functionalized organic or organometallic compound further comprising a first functional group; and
said second designed and functionalized organic or organometallic compound further comprising a second functional group.

20. The method according to claim 14, further comprising:
said first designed and functionalized organic or organometallic compound further comprising a first partially unsaturated carbon skeleton; and
said second designed and functionalized organic or organometallic compound further comprising a second partially unsaturated carbon skeleton.

21. The method according to claim 14, further comprising:
said first designed and functionalized organic or organometallic compound further comprising a first aliphatic organometallic compound; and
said second designed and functionalized organic or organometallic compound further comprising a second aliphatic organometallic compound.

22. The method according to claim 14, further comprising:
said first designed and functionalized organic or organometallic compound further comprising a first aromatic organometallic compound; and
said second designed and functionalized organic or organometallic compound further comprising a second aromatic organometallic compound.

23. The method according to claim 14, wherein said conductive or semiconducting nanoparticles further comprising carbon powder.
